(19) United States
(12) Patent Application Publication
(10) Pub. No.: US 2014/0068001 A1
(43) Pub. Date: Mar. 6, 2014

(54) INTERMEDIATE PROXY SERVER, COMMUNICATION METHOD, AND COMMUNICATION SYSTEM BASED ON HTTP MULTI-LEVEL PROXY

(71) Applicant: Tencent Technology (Shenzhen) Company Limited, Shenzhen (CN)

(72) Inventors: JINLONG SHEN, Shenzhen (CN); LI KONG, Shenzhen (CN)

(73) Assignee: Tencent Technology (Shenzhen) Company Limited, Shenzhen (CN)

(21) Appl. No.: 14/073,890

(22) Filed: Nov. 7, 2013

Related U.S. Application Data
(63) Continuation of application No. PCT/CN2013/077898, filed on Jun. 25, 2013.

(30) Foreign Application Priority Data
Jul. 5, 2012 (CN) 201210231737.5

(51) Int. Cl. H04L 29/08

(52) U.S. Cl. CPC H04L 67/02
USPC 709/217

(57) ABSTRACT

Various embodiments provide servers including an intermediate proxy server, communication methods, and communication systems based on HTTP multi-level proxy. An exemplary intermediate proxy server can be configured between a standard proxy server and a destination network terminal. The exemplary intermediate proxy server can be configured to receive a message forwarded by the standard proxy server. The message can include an HTTP header containing an address of the destination network terminal and an address of the intermediate proxy server. The intermediate proxy server can be connected to the destination network terminal according to the address of the destination network terminal in the HTTP header. The intermediate proxy server can be configured to send the message to the destination network terminal.

### CROSS-REFERENCES TO RELATED APPLICATIONS

This application is continuation application of PCT Patent Application No. PCT/CN2013/077898, filed on Jun. 25, 2013, which claims priority to Chinese Patent Application No. CN201210231737.5, filed on Jul. 5, 2012, the entire content of both of which are incorporated herein by reference.

### FIELD OF THE DISCLOSURE

The present disclosure relates to the field of Hypertext Transfer Protocol (HTTP) proxy technologies and, more particularly, relates to communication methods, communication systems, and intermediate proxy servers based on HTTP multi-level proxy.

### BACKGROUND

Currently, Hypertext Transfer Protocol (HTTP) is a network protocol most-widely used in the Internet. Files transmitted over the Internet must comply with the HTTP standard. HTTP is originally designed for the purposes to provide a method for publishing and receiving an HTML (i.e., Hypertext Markup Language) page.

Proxy is a special kind of Internet network service that allows a network terminal (e.g., a client) to be indirectly connected with another network terminal (e.g., a target server) via a proxy service, also known as a network proxy. In an example having a network proxy communication between a client and a target server, as shown in FIG. 1, the client and the target server are respectively connected to a standard proxy server. According to the HTTP standard, the client may access the target server and the target server may return resources to the client via the standard proxy server.

However, there is only one network proxy often used for communications between different network terminals. It is therefore desirable to achieve multiple levels of proxy to provide convenience in practical.

### BRIEF SUMMARY OF THE DISCLOSURE

According to various embodiments, there is provided a server including an intermediate proxy server. The intermediate proxy server can be configured between a standard proxy server and a destination network terminal and configured to receive a message forwarded by the standard proxy server. The message can include an HTTP header containing an address of the destination network terminal and an address of the intermediate proxy server. The intermediate proxy server can be connected to the destination network terminal according to the address of the destination network terminal in the HTTP header. The intermediate proxy server can be configured to send the message to the destination network terminal.

According to various embodiments, there is also provided a communication method based on HTTP multi-level proxy. In this method, a message forwarded by a standard proxy server according to an address contained in an HTTP header of the message can be received by an intermediate proxy server. The message can be sent from a source network terminal to the standard proxy server. The HTTP header of the message can further contain an address of a destination network terminal. The message can be sent by the intermediate proxy server to the destination network terminal according to the address of the destination network terminal in the HTTP header.

According to various embodiments, there is further provided a communication method based on HTTP multi-level proxy. In this method, a message can be received by a standard proxy server. The message can contain an address of a destination network terminal and an address of an intermediate proxy server in an HTTP header. The standard proxy server can be connected to a corresponding intermediate proxy server according to the address of the intermediate proxy server in the HTTP header. The message can be forwarded by the standard proxy server to the intermediate proxy server. The intermediate proxy server can be connected to a corresponding destination network terminal according to the address of the destination network terminal in the HTTP header. The message can be sent by the intermediate proxy server to the destination network terminal.

According to various embodiments, there is further provided a communication system based on HTTP multi-level proxy. The system can include a standard proxy server and an intermediate proxy server. The standard proxy server can be configured to receive a message containing an address of the intermediate proxy server and an address of a destination network terminal in an HTTP header of the message. The standard proxy server can be configured to forward the message to the intermediate proxy server according to the address of the intermediate proxy server contained in the HTTP header. The intermediate proxy server can be configured to receive the message from the standard proxy server and to send the message to the destination network terminal according to the address of the destination network terminal in the HTTP header.

Various embodiments provide servers including an intermediate proxy server, communication methods, and communication systems based on HTTP multi-level proxy to achieve multiple levels of HTTP proxy. In addition, various embodiments can use a variety of functions provided by the intermediate proxy servers to improve data transfer performance. For example, the use of the intermediate proxy server to provide data compression, spam filtering (e.g., advertisement filtering, etc.), and other functions can reduce message traffic for interactions between a source network terminal and a destination network terminal to improve transmission efficiency. The intermediate proxy server can also share the handling stress of a standard proxy server to reduce the burden on the standard proxy server.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a diagram using a network proxy communication between a client and a target server;

FIG. 2 depicts a structural diagram illustrating an exemplary communication system based on HTTP multi-level proxy in accordance with various disclosed embodiments;

FIG. 3 depicts an exemplary communication method based on HTTP multi-level proxy in accordance with various disclosed embodiments; and

FIG. 4 depicts another exemplary communication method based on HTTP multi-level proxy in accordance with various disclosed embodiments.

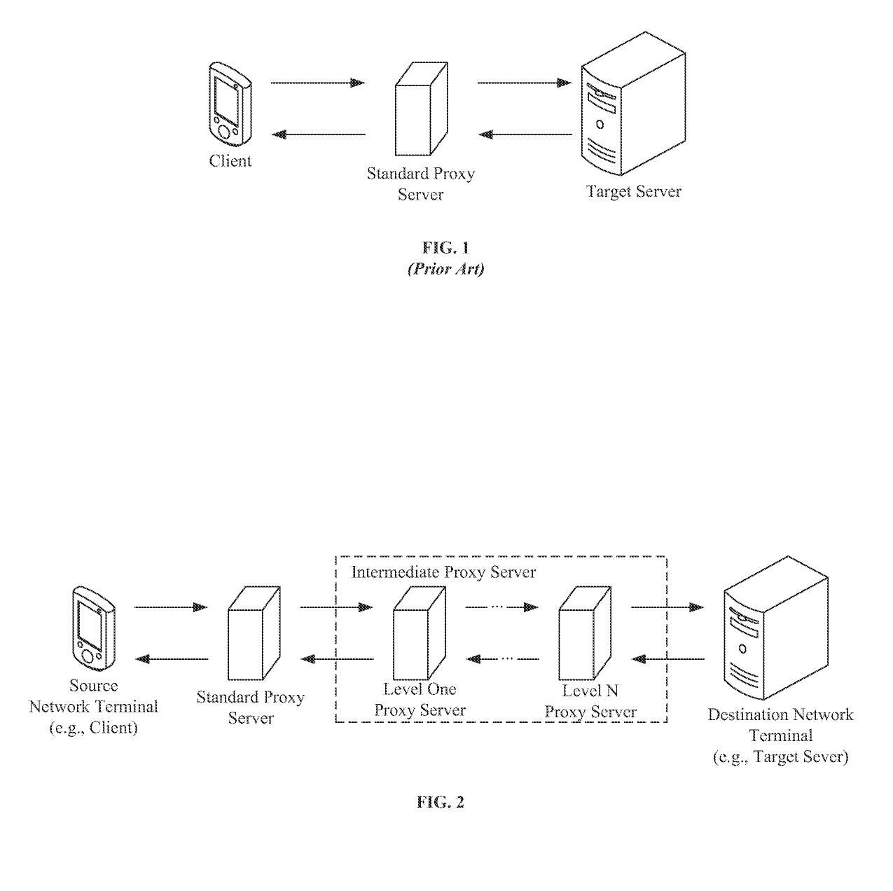

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

FIG. 2 depicts a structural diagram illustrating an exemplary system based on HTTP multi-level proxy in accordance with various disclosed embodiments. The exemplary system can include a source network terminal, a standard proxy server, a destination network terminal, and/or an intermediate proxy server configured between the standard proxy server and the destination network terminal.

The source network terminal can be configured to create a connection with the standard proxy server and to send a message to the standard proxy server. The message can include an HTTP header containing an address of the destination network terminal and an address of the intermediate proxy server.

The standard proxy server can be configured, according to the address of the intermediate proxy server in the HTTP header, to connect to a corresponding intermediate proxy server and to forward the message to the intermediate proxy server.

The intermediate proxy server can be configured, according to the address of the destination network terminal in the HTTP header, to connect to a corresponding destination network terminal and to send the message to the destination network terminal. The destination network terminal can be configured to receive the message forwarded by the intermediate proxy server.

The source network terminal can use the address of the intermediate proxy server to set a value for a first Host parameter in the HTTP header, and use the address of the destination network terminal to additionally set a value for a second Host parameter. In some cases, the first Host parameter can be a Host parameter in the existing HTTP header, and the second Host parameter can be an added Host parameter added in the HTTP header in accordance with various disclosed embodiments.

In an exemplary embodiment, as shown in FIG. 2, the intermediate proxy server can be formed including various levels (e.g., N levels) of proxy servers, where N can be an integer greater than or equal to about 1.

When N is 1, that is, when there is only one intermediate proxy server, in the HTTP header of a message sent from the source network terminal to the standard proxy server, a value of the first Host parameter is set to be an address of a level one (i.e., first-level) proxy server and a value of a second Host parameter is additionally set to be an address of the destination network terminal. The level one proxy server, according to the second Host parameter in the HTTP header, can be connected to a corresponding destination network terminal, and can send the message to the destination network terminal.

When N is an integer greater than or equal to about 2, in the HTTP header of a message sent from the source network terminal to the standard proxy server, a value of the first Host parameter is set to be an address of a level one proxy server and a value of a second Host parameter is additionally set to be an address of the destination network terminal. A level (N−1) proxy server can send the message to a level N proxy server. According to the second Host parameter in the HTTP header, the level N proxy server can be connected to a corresponding destination network terminal, and can send the message to the destination network terminal.

In addition, when the destination network terminal needs to return a message to the source network terminal, the destination network terminal can send the returned message to the intermediate proxy server; the intermediate proxy server can send the returned message to the standard proxy server; and the standard proxy server can send the returned message to the source network terminal. If the intermediate proxy server includes N levels of proxy servers, the destination network terminal can send the returned message to a level N proxy server, the level N proxy server can send the returned message to a level N−1 proxy server, the level N−1 proxy server can send the returned message to a level N−2 proxy server, and so on. The level one (first-level) proxy server can send the returned message to the standard proxy server and the standard proxy server can then send the returned message back to the source network terminal.

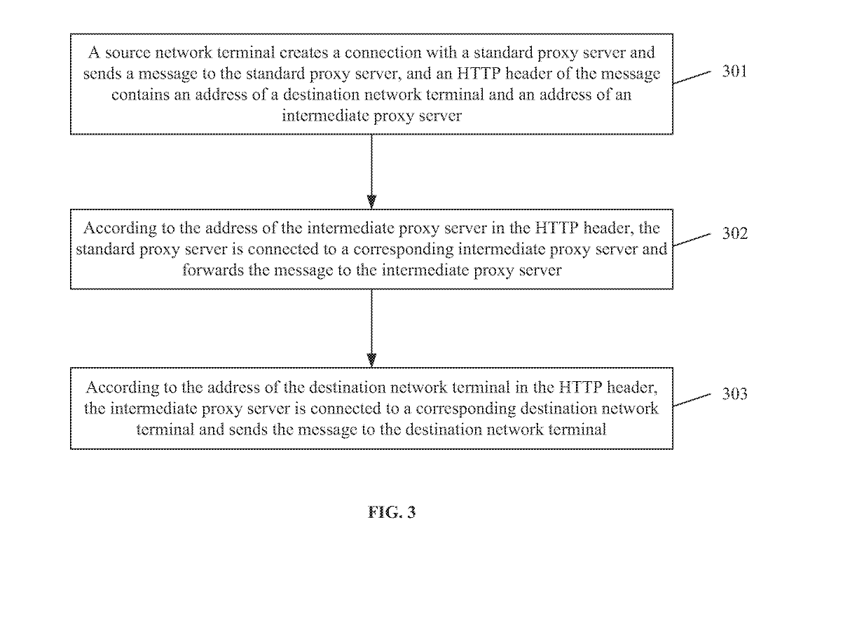

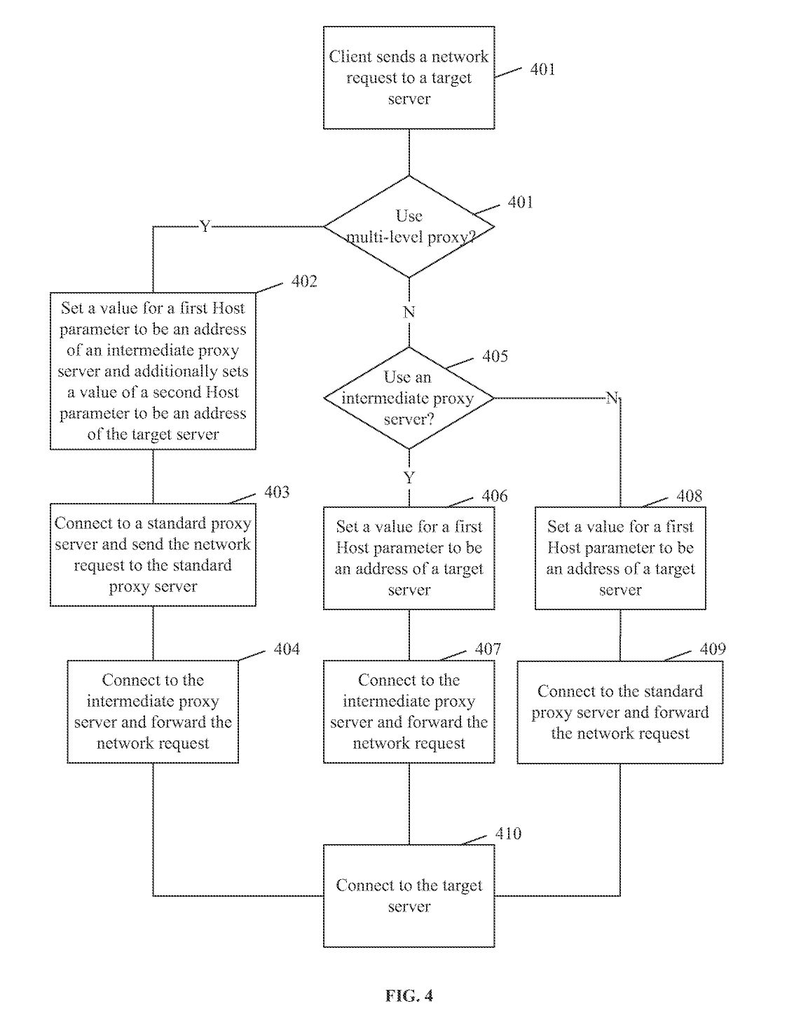

FIG. 3 depicts an exemplary communication method based on HTTP multi-level proxy in accordance with various disclosed embodiments. In Step 301, a source network terminal can create a connection with a standard proxy server and send a message to the standard proxy server. An HTTP header of the message can contain an address of a destination network terminal and an address of an intermediate proxy server.

Containing an address of the destination network terminal and an address of the intermediate proxy server in the HTTP header can include setting a value for a first Host parameter in the HTTP header using the address of the intermediate proxy server, and additionally setting a value for a second Host parameter using the address of the destination network terminal.

In Step 302, according to the address of the intermediate proxy server in the HTTP header, the standard proxy server can be connected to a corresponding intermediate proxy server, and forward the message to the intermediate proxy server.

In Step 303, according to the address of the destination network terminal in the HTTP header, the intermediate proxy server can be connected to a corresponding destination network terminal, and send the message to the destination network terminal. In an exemplary embodiment, the intermediate proxy server can include various levels (e.g., N levels) of proxy servers, where N can be an integer greater than or equal to about 1.

When N is 1, that is, when there is only one intermediate proxy server, in the HTTP header of a message sent from the source network terminal to the standard proxy server, a value of the first Host parameter is set to be an address of a level one proxy server and a value of a second Host parameter is additionally set to be an address of the destination network terminal. The level one proxy server, according to the second Host parameter in the HTTP header, can be connected to a corresponding destination network terminal, and can send the message to the destination network terminal.

When N is greater than or equal to about 2, in the HTTP header of a message sent from the source network terminal to the standard proxy server, a value of the first Host parameter is set to be an address of a level one proxy server and a value of a second Host parameter is additionally set to be an address of the destination network terminal. The level (N−1) proxy server can send the message to the level N proxy server, and so on. According to the second Host parameter in the HTTP header, the level N proxy server can be connected to a corresponding destination network terminal, and can send the message to the destination network terminal.

In addition, when the destination network terminal needs to return a message to the source network terminal, the destination network terminal can send the returned message to the intermediate proxy server, the intermediate proxy server can send the returned message to the standard proxy server, and the standard proxy server can then send the returned message to the source network terminal. If the intermediate proxy server includes N levels of proxy servers, the destination network terminal can send the returned message to the level N proxy server, the level N proxy server can send the returned message to the level N−1 proxy server, and so on. The level one (first-level) proxy server can send the returned message to the standard proxy server, and the standard proxy server can send the returned message back to the source network terminal.

In an exemplary embodiment, the intermediate proxy server can conduct a spam filtering (e.g., advertisement filtering, etc.) to messages interacted between the source network terminal and the destination network terminal, and/or conduct a compression processing or any other suitable processes; and then forward the processed messages. Via these functions provided by the intermediate proxy server, message traffic for interactions between the source network terminal and the destination network terminal can be reduced. Transmission performance can be improved. The intermediate proxy server can also share handling stress of the standard proxy server to reduce the burden on the standard proxy server. According to various embodiments, capabilities/functions of the intermediate proxy server used herein are not limited and may be expanded as desired.

In various embodiments, the source network terminal can be, for example, a client; and the destination network terminal can be, for example, a target server. In a specific embodiment, a client can request a target server for network connection services (e.g., request to access www.qq.com), and a communication system (e.g., as depicted in FIG. 2) based on HTTP multi-level proxy can be used in accordance with various embodiments.

FIG. 4 depicts another exemplary communication method based on HTTP multi-level proxy in accordance with various disclosed embodiments. In Step 401, when a client needs to send to a target server a network request to connect to www.qq.com, it is determined whether a multi-level proxy is used. If it is determined to use the multi-level proxy, the method proceeds to perform Step 402. If it is not determined to use the multi-level proxy, the method proceeds to perform Step 405.

In Step 402, the client sets a value for a first Host parameter in an HTTP header of the network request to be an address of an intermediate proxy server and additionally sets a value of a second Host parameter to be an address of the target server (i.e., www.qq.com).

It should be noted that, if the intermediate proxy server is formed by N levels of proxy servers and N is greater than or equal to about 2, the value for the first Host parameter set by the client in the HTTP header of the network request can be an address of a first level proxy server and the value for the second Host parameter additionally set by the client can be an address of the target server (i.e., www.qq.com).

In Step 403, the client creates a connection with the standard proxy server and sends the network request to the standard proxy server. In Step 404, the standard proxy server, according to the address of the intermediate proxy server in the HTTP header, is connected to a corresponding intermediate proxy server, and forwards the network request to the intermediate proxy server. The method then proceeds to perform Step 410.

In an exemplary embodiment, when the intermediate proxy server includes N levels of proxy servers and N is greater than or equal to about 2, the standard proxy server, according to the first Host parameter in the HTTP header, can be connected to a corresponding level one proxy server and then forward the network request to the level one proxy server. The level one proxy server can forward the network request to a level two proxy server. The first Host parameter in the HTTP header of the forwarded network request can be set to be an address of the second level proxy server and the second Host parameter can be set to be an address of the target server, and so on. For example, a level (N−1) proxy server can forward the network request to the level N proxy server. The first Host parameter in the HTTP header of the forwarded network request can be set to be an address of the level N proxy server and the second Host parameter can be set to be an address of the target server (i.e., www.qq.com).

In Step 405, it is determined whether to use the intermediate proxy server. If the intermediate proxy server is determined to be used, the method proceeds to perform Step 406. If the intermediate proxy server is determined not to be used, the method then proceeds to perform Step 408.

In Steps 406-407, the client sets the first Host parameter in the HTTP header of the network request to be the address of the target server (i.e., www.qq.com). The client is connected to the intermediate proxy server, and then forwards the network request to the intermediate proxy server. The method then proceeds to perform Step 410.

In an exemplary embodiment, if the intermediate proxy server is formed by N levels of proxy servers and N is greater than or equal to about 2, the client can, in the HTTP header of the network requests, set the first Host parameter to be the address of the target server, and send the network request to a level one proxy server. The level one proxy server can forward the network request to a level two network proxy server, and so on. A level N−1 proxy server can forward the network request to a level N proxy server.

In Steps 408-409, the client sets the first Host parameter in the HTTP header of the network request to be the address of the target server (i.e., www.qq.com). The client is connected to the standard proxy server and forwards the network request to the standard proxy server. The method then proceeds to perform Step 410.

Referring back to FIG. 4, after performing Step 404 and in Step 410, the intermediate proxy server is connected to the target server according to a value of the second Host parameter, and sends the network request to the target server. When the intermediate proxy server is formed by N levels of proxy servers and N is greater than or equal to about 2, the level N proxy server can be connected to a corresponding target server according to a value of the second Host parameter in the HTTP header of the received network request, and can send the network request to the target server. In this network request, the value of the first Host parameter in the HTTP header can be set to be the address of the target server, and the network request no longer carries the second Host parameter.

As shown in FIG. 4, after performing Step 407 and in Step 410, the intermediate proxy server, according to the value the first Host parameter, is connected to the target server, and sends the network request to the target server. If the intermediate proxy server is formed by N levels of proxy servers and N is greater than or equal to about 2, the level N proxy server, according to the value of the first Host parameter in the HTTP header of the received network request can be connected to a corresponding target server and send the network request to the target server.

As shown in FIG. 4, after performing Step 409 and in Step 410, the standard proxy server, according to the value of the first Host parameter, is connected to the target server, and then sends the network request to the target server. Further, after performing Step 410, the target server returns a network resource requested by the client to the client, which can include the following.

In one example, if the client's network request is sequentially sent to the target server via the standard proxy server and the intermediate proxy server, the target server's network resource can return to the client along the path including the intermediate proxy server and the standard proxy server. In another example, if the client's network request is sent to the target server via the standard proxy server, the target server's network resource can be returned to the client via the standard proxy server.

In yet another example, if the client's network request is sent to the target server via the intermediate proxy server, the target server's network resource can be returned to the client via the intermediate proxy server.

The disclosed embodiments can be examples only. One of ordinary skill in the art would appreciate that suitable software and/or hardware (e.g., a universal hardware platform) may be included and used to perform the disclosed methods. For example, the disclosed embodiments can be implemented by hardware only, which alternatively can be implemented by software products only. The software products can be stored in a storage medium. The software products can include suitable commands to enable any client device (e.g., including a mobile phone, a personal computer, a server, or a network device, etc.) to implement the disclosed embodiments.

Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Various embodiments provide servers including an intermediate proxy server, communication methods, and communication systems based on HTTP multi-level proxy to achieve multiple levels of HTTP proxy. An exemplary server can include an intermediate proxy server. The intermediate proxy server can be configured between a standard proxy server and a destination network terminal and configured to receive a message forwarded by the standard proxy server. The message can include an HTTP header containing an address of the destination network terminal and an address of the intermediate proxy server. The intermediate proxy server can be connected to the destination network terminal according to the address of the destination network terminal in the HTTP header. The intermediate proxy server can be configured to send the message to the destination network terminal.

In an exemplary communication method based on HTTP multi-level proxy, a message forwarded by a standard proxy server according to an address contained in an HTTP header of the message can be received by an intermediate proxy server. The message can be sent from a source network terminal to the standard proxy server. The HTTP header of the message can further contain an address of a destination network terminal. The message can be sent by the intermediate proxy server to the destination network terminal according to the address of the destination network terminal in the HTTP header.

An exemplary system can include a standard proxy server and an intermediate proxy server. The standard proxy server can be configured to receive a message containing an address of the intermediate proxy server and an address of a destination network terminal in an HTTP header of the message. The standard proxy server can be configured to forward the message to the intermediate proxy server according to the address of the intermediate proxy server contained in the HTTP header. The intermediate proxy server can be configured to receive the message from the standard proxy server and to send the message to the destination network terminal according to the address of the destination network terminal in the HTTP header.

In addition, various embodiments can use a variety of functions provided by the intermediate proxy servers to improve data transfer performance. For example, the use of the intermediate proxy server to provide data compression, spam filtering (e.g., advertisement filtering, etc.), and other functions can reduce message traffic for interactions between a source network terminal and a destination network terminal to improve transmission efficiency. The intermediate proxy server can also share the handling stress of a standard proxy server to reduce the burden on the standard proxy server.

What is claimed is:

1. A server comprising:
an intermediate proxy server, configured between a standard proxy server and a destination network terminal and configured to receive a message forwarded by the standard proxy server, wherein the message comprises an HTTP header containing an address of the destination network terminal and an address of the intermediate proxy server; and
wherein the intermediate proxy server is connected to the destination network terminal according to the address of the destination network terminal in the HTTP header, and is configured to send the message to the destination network terminal.

2. The server of claim 1, wherein a value for a first Host parameter in the HTTP header is set to be the address of the intermediate proxy server and a value for a second Host parameter is set to be the address of the destination network terminal.

3. The server of claim 1, wherein the intermediate proxy server comprises N levels of proxy servers, N being an integer greater than or equal to about 1.

4. The server of claim 2, wherein the intermediate proxy server comprises N levels of proxy servers and N is greater than or equal to about 2,
wherein the value of the first Host parameter is set to be an address of a level one proxy server and the value of the second Host parameter is set to be the address of the destination network terminal in the HTTP header of the message sent from a source network terminal to the standard proxy server, and
wherein a level (N−1) proxy server sends the message to a level N proxy server, and according to the second Host parameter in the HTTP header, the level N proxy server is connected to a corresponding destination network terminal and sends the message to the destination network terminal.

5. The server of claim 1, wherein the intermediate proxy server is further configured, when receiving a message returned from the destination network terminal, to send the returned message to a source network terminal via the standard proxy server.

6. A communication method based on HTTP multi-level proxy comprising:
receiving, by an intermediate proxy server, a message forwarded by a standard proxy server according to an address contained in an HTTP header of the message, wherein the message is sent from a source network terminal to the standard proxy server, and wherein the HTTP header of the message further contains an address of a destination network terminal; and
sending, by the intermediate proxy server, the message to the destination network terminal, according to the address of the destination network terminal in the HTTP header.

7. The method of claim 6, wherein the address of the intermediate proxy server is set as a value for a first Host parameter in the HTTP header of the message and the address of the destination network terminal is set as a value for a second Host parameter in the HTTP header of the message.

8. The method of claim 6, wherein the intermediate proxy server comprises N levels of proxy servers, N being an integer greater than or equal to about 1.

9. The method of claim 7, wherein the intermediate proxy server comprises N levels of proxy servers and N is greater than or equal to about 2,
wherein an address of a level one proxy server is set as the value of the first Host parameter and the address of the destination network terminal is set as the value of the second Host parameter in the HTTP header of the message; and
wherein a level (N−1) proxy server sends the message to a level N proxy server, and according to the second Host parameter in the HTTP header, the level N proxy server is connected to a corresponding destination network terminal and sends the message to the destination network terminal.

10. The method of claim 6, wherein the intermediate proxy server is further configured, when receiving a message returned from the destination network terminal, to send the returned message to the source network terminal via the standard proxy server.

11. A communication method based on HTTP multi-level proxy, the method comprising:
receiving, by a standard proxy server, a message, wherein the message contains an address of a destination network terminal and an address of an intermediate proxy server in an HTTP header;
connecting the standard proxy server to a corresponding intermediate proxy server according to the address of the intermediate proxy server in the HTTP header;
forwarding, by the standard proxy server, the message to the intermediate proxy server;
connecting the intermediate proxy server to a corresponding destination network terminal according to the address of the destination network terminal in the HTTP header; and
sending, by the intermediate proxy server, the message to the destination network terminal.

12. The method of claim 11, wherein the address of the intermediate proxy server is set as a value for a first Host parameter in the HTTP header of the message and the address of the destination network terminal is set as a value for a second Host parameter in the HTTP header of the message.

13. The method of claim 11, wherein the intermediate proxy server comprises N levels of proxy servers, N being an integer greater than or equal to about 1.

14. The method of claim 12, wherein the intermediate proxy server comprises N levels of proxy servers and N is greater than or equal to about 2,
wherein an address of a level one proxy server is set as the value of the first Host parameter and the address of the destination network terminal is set as the value of the second Host parameter in the HTTP header of the message; and
wherein a level (N−1) proxy server sends the message to a level N proxy server, and according to the second Host parameter in the HTTP header, the level N proxy server is connected to a corresponding destination network terminal and sends the message to the destination network terminal.

15. The method of claim 11, further comprising:
receiving, by the intermediate proxy server, a message returned from the destination network terminal; and
sending, by the intermediate proxy server, the returned message to a source network terminal via the standard proxy server.

16. The method of claim 15, wherein the source network terminal comprises a client, and the destination network terminal comprises a target server.
